(19) United States
(12) Patent Application Publication
(10) Pub. No.: US 2005/0036908 A1
(43) Pub. Date: Feb. 17, 2005

(54) Biochemical detecting device for magnetic beads and method using the same

(75) Inventors: Chih-Sheng Yu, Hsin-Chu City (TW); Yi-Chiuen Hu, Hsin-Chu City (TW); Ming-Yu Lin, Taipei City (TW); Hsiao-Yu Chou, Jhudong Township (TW); Chien-Jen Chen, Hsin-Chu City (TW); Shih-Jun Yuan, Taipei City (TW); Jing-Tang Yang, Hsin-Chu City (TW)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignees: Precision Instrument Development Center; National Tsing Hua University

(21) Appl. No.: 10/917,762

(22) Filed: Aug. 13, 2004

(30) Foreign Application Priority Data
Aug. 15, 2003 (TW) 092122573

(51) Int. Cl. G01N 21/00

(52) U.S. Cl. 422/58

(57) ABSTRACT

A biochemical detecting device for separating a reagent, a plurality of magnetic beads and a target from a mixture, and detecting the target is provided. The biochemical detecting device includes a first substrate, at least two first electrode sets located on the first substrate, a second electrode set located on the first substrate and between the two first electrode sets, and a second substrate covering the first substrate, each of the first electrode sets and the second electrode set. Accordingly, the movement of the mixture is digitally controlled by the provided biological detecting device.

### FIELD OF THE INVENTION

The present invention is related to a biochemical detecting device for magnetic beads, in particular, to the biochemical detecting device integrating a digital fluid for controlling the liquid drop with an electromagnetic field for purifying and separating the magnetic composites from the liquid drop.

### BACKGROUND OF THE INVENTION

In the biological and medical technologies, a precise analysis in a short time for identifying the classification of the pathogenic bacteria and the cells is required for a timely cure or treatment. In the analysis and detection, however, there are always multiple kinds of mixtures contained in the sample, such as the bloods, needed to be purified. Therefore, the thorny problems of rapid and exact cell purification and separation from the mixtures in the sample are necessary to be simplified.

The conventional techniques of the cell purification and separation relate to separating and purifying the cells from the mixtures by detecting the various biological information, which is resulted from the different intrinsic properties of the cell or the organism, such as the cell sizes, the electric charges and the cell labels of fluorescence or magnetism. By an appropriate purification and separation, it is possible to complete an accurate classification in a micro-scale biological system, and moreover, the information of a specific cell is obtained without destroying the structure thereof. Additionally, a great amount of the specific cells are further obtained for being analyzed through a cultivation of the purified cells.

The flow cytometer is an advanced instrument, which can detect the physical or chemical property of a single cell or a biological particle. After the cell acting with an antibody, which is combined with the fluorescent dyes, the fluorescence on the cell is excited to generate the light with different wavelengths, when the cell is irradiated by a laser source. The light with various wavelengths pass through an optical filter for being selected according to a determined wavelength. Finally, the light with a specific wavelength is received by a PMT (Photo-multiple tube) for being amplified and transformed into a treated data for being stored. The flow cytometer is able to automatically be operated for the biochemical detection, however, such an instrument is too huge and costs to much to be popularly applied.

A novel technique of the magnetic-bead separation is being developed nowadays. By the attachments of the molecules or the cells on the magnetic beads, which are surface-modified, the molecules or the cells would be separated from the sample when a magnetic field is applied thereon. In other words, the surface-modified magnetic beads are attracted by the magnetic field, which results in a cell separation and purification from the sample, and furthermore, the surface-modified magnetic beads would work as carriers for carrying the target cells and molecules to a specific position.

Three steps are involved in the magnetic-bead separation, which relates to utilizing the magnetic labeling for the cell purification. First, the cells are mixed with the surface-modified magnetic beads to form a magnetic composite. Second, r the magnetic composite is washed repeatedly to remove the reagents which are needless. Finally, the magnetic composite is separated and purified by a magnetic force applied by a field.

The magnetic-bead separation provides an effective detection for a trace of reagents with an extremely low concentration (pg/l), which can not be detected through the conventional immunological analysis, and the molecular information is accordingly detectable. Furthermore, as the Bio-MEMS being developing, such a seperation technique also provides a detecting method, and through the method, it is possible to offer a compactness of the detecting system, a higher purity of the analyzed sample and a short time of the reaction.

Based on the above, an integrated detecting device relative to the novel magnetic-bead separation is necessary nowadays. In order to overcome the drawbacks in the prior art, a biological detecting device for magnetic beads, in particular, a biological detecting device integrating a digital fluid for controlling the liquid drop with an electromagnetic field for purifying and separating the magnetic composites from the liquid drop is provided in the present invention.

### SUMMARY OF THE INVENTION

In accordance with an aspect of the present invention, a biochemical detecting device for separating a reagent, a plurality of magnetic beads and a target from a mixture, and detecting the target is provided. The biochemical detecting device includes a first substrate, at least two first electrode sets located on the first substrate, a second electrode set located on the first substrate and between the two first electrode sets, and a second substrate covering the first substrate, each of the first electrode sets and the second electrode set.

Preferably, a movement of the mixture is digitally controlled.

Preferably, the reagent and the plurality of magnetic beads move and interact between the first substrate and the second substrate when a first current is applied to the first electrode sets.

Preferably, the plurality of magnetic beads are attracted by the second electrode set.

Preferably, the target is identified and detected through a fluorescence signal of the reagent attached on the target when a second current is applied to the second electrode set.

Preferably, a certain reaction of the target is initiated to generate a current signal to be detected when a third current is applied to one of the first electrode sets.

Preferably, the target is a mixture of blood and a dye agent.

Preferably, the first substrate and the second substrate are silicon substrates.

Preferably, the first substrate and the second substrate are glass substrates.

Preferably, the first electrode set and the second electrode set are electromagnetic coils.

Preferably, the first electrode set and the second electrode set are inductors.

Preferably, each of the current signal and the fluorescence signal is forwarded by the first electrode set to be detected.

In accordance with another aspect of the present invention, a biochemical detecting method for detecting a target in a plurality of magnetic beads of a liquid drop by a biochemical detecting device is provided. The method includes steps of mixing a target, a reagent having a fluorescence signal, and a plurality of magnetic beads to form a fluid, driving the fluid by a first electrode set of the biochemical detecting device such that the fluid moves to a second electrode set of the biological detecting device, attracting the plurality magnetic beads by the second electrode set, and identifying and detecting the fluorescence signal of the reagent adsorbed on the target.

Preferably, the target is adsorbed by the plurality of magnetic beads.

Preferably, the biochemical detecting device further includes a first substrate, at least two first electrode sets located on the first substrate, a second electrode set located on the first substrate and between the two first electrode sets, and a second substrate covering the first substrate, each of the first electrode sets and the second electrode set.

Preferably, the reagent and the plurality of magnetic beads are able to move and interact between the first substrate and the second substrate when a first current is applied to the first electrode sets.

Preferably, the plurality of magnetic beads are attracted by the second electrode set, and the target is identified and detected through a fluorescence signal of the reagent attached on the target, when a second current is applied to the second electrode set.

Preferably, a certain reaction of the target is initiated to generate a current signal to be detected when a third current is applied to one of the first electrode sets.

In accordance with another aspect of the present invention, a biochemical detecting method for detecting a target in a plurality of magnetic beads of a liquid drop by a biochemical detecting device provided in the present invention includes steps of mixing a target, a reagent and a plurality of magnetic beads to form a fluid, driving the fluid by a first electrode set of the biochemical detecting device such that the fluid moves to a second electrode set of the biological detecting device, attracting the plurality magnetic beads by the second electrode set, and identifying and detecting the current signal of the reagent adsorbed on the target.

Preferably, the target is adsorbed by the plurality of magnetic beads.

Preferably, the biochemical detecting device further includes a first substrate, at least two first electrode sets located on the first substrate, a second electrode set located on the first substrate and between the two first electrode sets, and a second substrate covering the first substrate, each of the first electrode sets and the second electrode set.

Preferably, the reagent and the plurality of magnetic beads are able to move and interact between the first substrate and the second substrate when a first current is applied to the first electrode sets.

Preferably, the plurality of magnetic beads are attracted by the second electrode set, and the target is identified and detected through a fluorescence signal of the reagent attached on the target, when a second current is applied to the second electrode set.

Preferably, a certain reaction of the target is initiated to generate a current signal to be detected when a third current is applied to one of the first electrode sets.

The foregoing and other features and advantages of the present invention will be more clearly understood through the following descriptions with reference to the drawings, wherein:

### BRIEF DESCRIPTION OF THE DRAWINGS

FIG. 1 is a diagram illustrating the structure of the biochemical detecting device according to the preferred embodiment of the present invention;

FIG. 2 is a diagram further illustrating the purifying zone of the biological detecting device according to the preferred embodiment of the present invention; and

FIGS. 3(a) to 3(d) are diagrams schematically illustrating the processes of the magnetic composites purification according to the preferred embodiment of the present invention.

### DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

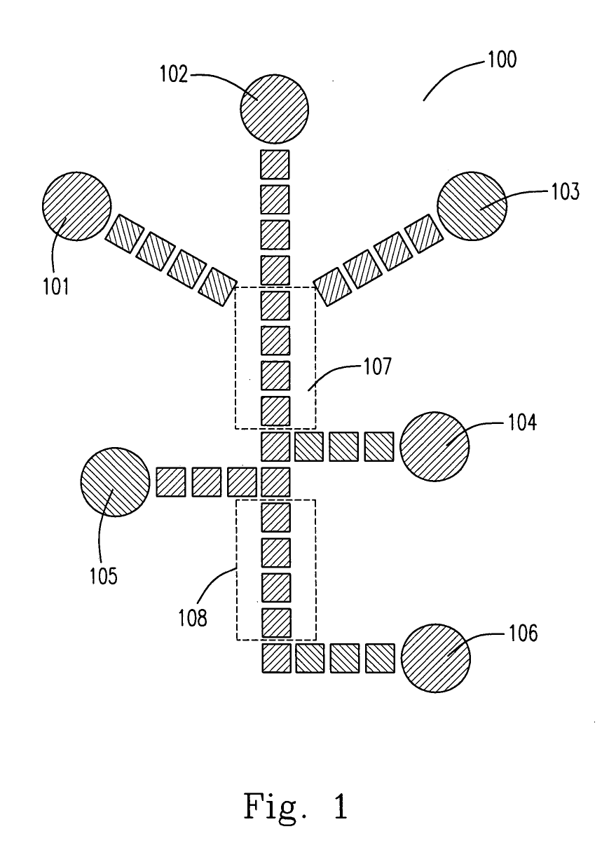

Please refer to FIG. 1, which illustrates the structure of the biochemical detecting device for magnetic beads according to the preferred embodiment of the present invention. Such a structure of the biochemical detecting device 100 is able to integrate a digital fluid (not shown) for controlling the liquid drop with an electromagnetic field for purifying and separating the magnetic composites from the liquid drop. The structure of the detecting device 100 includes a first fillister 101 for the surface-modified magnetic beads, a second fillister 102 for the targets, a third fillister 103 for the reagents, a fourth fillister 104 for the labeling reagents for labeling the targets, a fifth fillister 105 for the dye agents and a sixth fillister 106 for the waste liquids. The mixing zone 107 for the samples and the purifying zone 108 will be further described in the following.

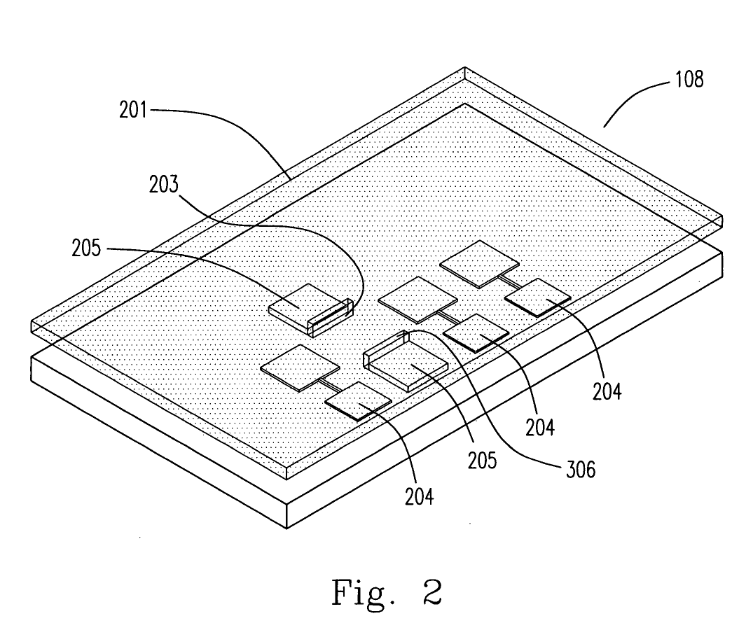

Please refer to FIG. 2, which illustrates the purifying zone of the biochemical detecting device according to FIG. 1. The purifying zone 108 further includes a covering lid 201, a substrate 202, a first attracting side 203 for attracting the magnetic composites, an electrode 204 and a magnetic element 205. Furthermore, the hydrophobic and dielectric layer is also involved in the biochemical detecting device but not shown in FIG. 2.

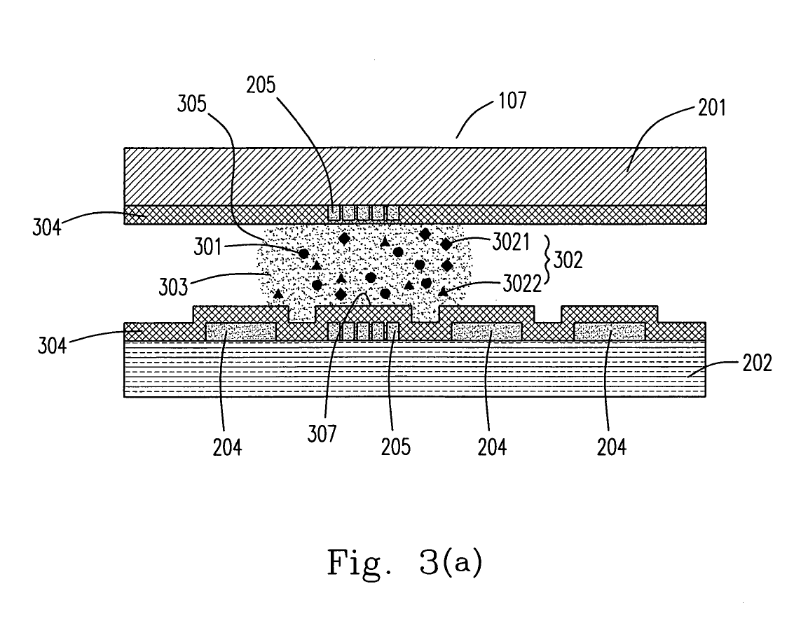

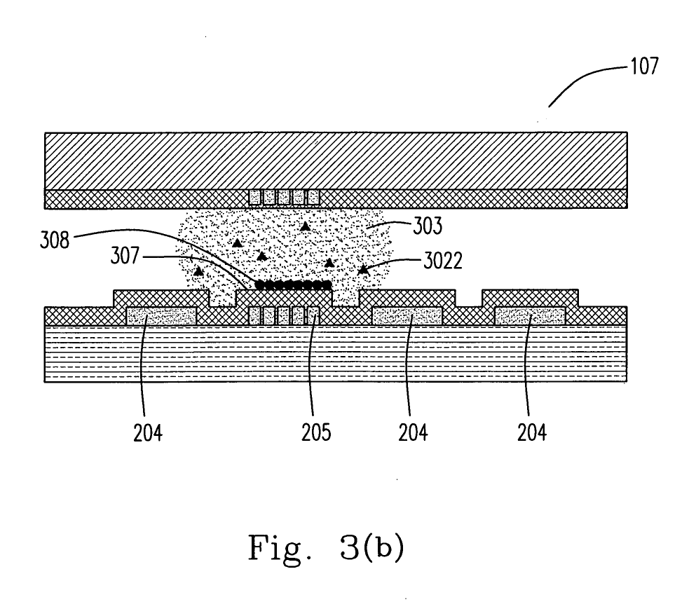

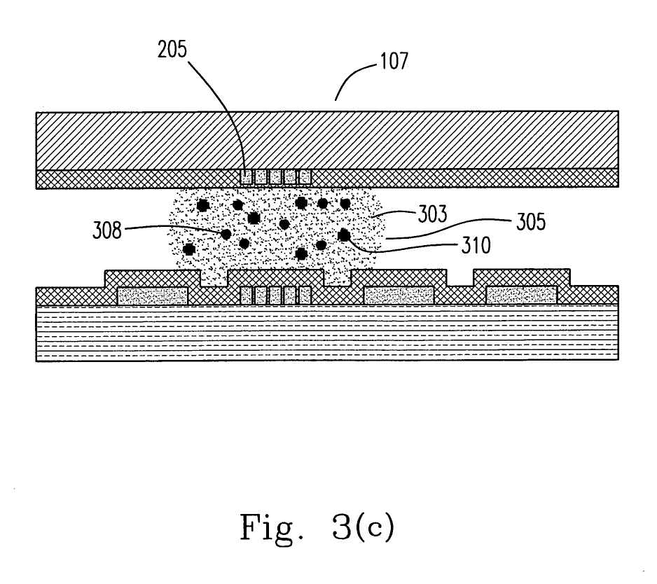

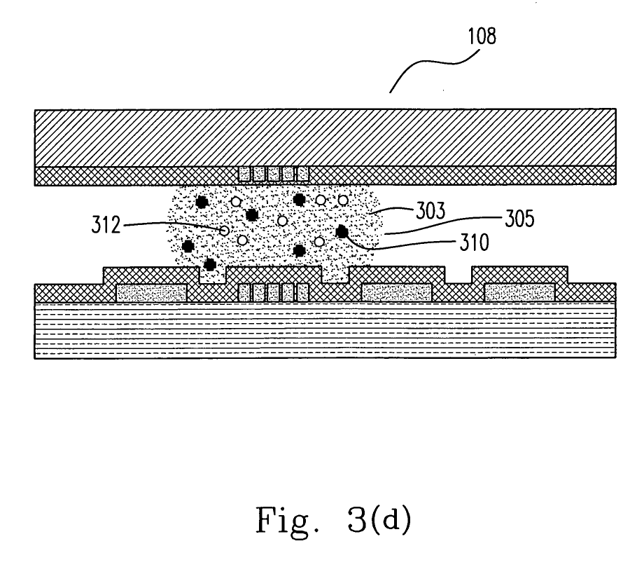

Please refer to FIGS. 3(a) to 3(d), which are diagrams schematically illustrating the processes of the magnetic composites purification and detection by using the biochemical detecting device according to FIG. 2.

As shown in FIG. 3(a), the mixing zone 107, i.e. the mixing zone 107 in FIG. 1, of the biochemical detecting device includes the covering lid 201, the substrate 202, the electrode 204 and the magnetic elements 205. Furthermore, the hydrophobic and dielectric layers 304 are also involved in the mixing zone 107. The surface-modified magnetic beads 301, the targets 302 including the specific and the non-specific targets 3021 and 3022, and the reagent 303 are respectively dropped into the first, the second and the third fillisters (referring to the first fillister 101, the second fillister 102 and the third fillister 103 in FIG. 1). By controlling the electrodes (not shown in FIG. 3(a)), the specific target 3021, the non-specific target 3022, the reagent 303 and the surface-modified magnetic beads 301 are driven to move to the mixing zone 107 and then, they are sufficiently mixed by the electrode 204 to form a liquid drop 305. At the moment, the specific target 3021 would further react with the surface-modified magnetic beads 301 to form a first magnetic composite (not shown).

Referring to FIG. 3(b), the first magnetic composite 308 is driven by the electrodes 204 to stay on the second attracting side 307 for a while. A magnetic field is applied to the magnetic element 205 so as to attract the first magnetic composite 308 on the second attracting side 307. Moreover, the reagents 303 are injected into the mixing zone 107 to wash out and remove the non-specific target 3022 to the sixth fillister (not shown).

Please refer to FIGS. 3(c) and 3(d). When the magnetic field of the magnetic element 205 vanishes, the first magnetic composite 308 would be suspended in the reagents 303. Then, the liquid drop 305 is electrically driven to move to the purifying zone 108 of the biochemical detecting device (please refer to FIG. 1). By adopting the digital fluid controlling techniques, the first magnetic composite 308 and the labeling reagent 310 of the liquid drop 305 are mixed sufficiently in the purifying zone 108 to further form a secondary magnetic composite 312 (as shown in FIG. 3(d)). Accordingly, the secondary magnetic composite 312 is detected in the purifying zone 108.

Based on the above, techniques of the fluid digitally controlling and the magnetic beads separation and purification based on the electromagnetic field are successfully integrated by the biochemical detecting device of the present invention. Hence, the present invention not only has a novelty and a progressiveness, but also has an industry utility.

While the invention has been described in terms of what is presently considered to be the most practical and preferred embodiment, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A biochemical detecting device for separating a reagent, a plurality of magnetic beads and a target from a mixture, and detecting said target, comprising:
a first substrate;
at least two first electrode sets located on said first substrate;
a second electrode set located on said first substrate and between said two first electrode sets; and
a second substrate covering said first substrate, each of said first electrode sets and said second electrode set, wherein a movement of said mixture is digitally controlled.

2. The biochemical detecting device according to claim 1, wherein said reagent and said plurality of magnetic beads move and interact between said first substrate and said second substrate when a first current is applied to said first electrode sets; said plurality magnetic beads are attracted by said second electrode set, and said target is identified and detected through a fluorescence signal of said reagent attached on said target when a second current is applied to said second electrode set; and a certain reaction of said target is initiated to generate a current signal to be detected when a third current is applied to one of said first electrode sets.

3. The biochemical detecting device according to claim 1, wherein said target is a mixture of blood and a dye agent.

4. The biochemical detecting device according to claim 1, wherein said first substrate and said second substrate are silicon substrates.

5. The biochemical detecting device according to claim 1, wherein said first substrate and said second substrate are glass substrates.

6. The biochemical detecting device according to claim 1, wherein said first electrode set and said second electrode set are electromagnetic coils.

7. The biochemical detecting device according to claim 1, wherein said first electrode set and said second electrode set are inductors.

8. The biochemical detecting device according to claim 1, wherein each of said current signal and said fluorescence signal is forwarded by said first electrode set to be detected.

9. A biochemical detecting method for detecting a target in a plurality of magnetic beads of a liquid drop by a biochemical detecting device, comprising steps of:
mixing a target, a reagent having a fluorescence signal, and a plurality of magnetic beads to form a fluid, wherein said target is adsorbed by said plurality of magnetic beads;
driving said fluid by a first electrode set of said biochemical detecting device such that said fluid moves to a second electrode set of said biological detecting device;
attracting said plurality magnetic beads by said second electrode set; and
identifying and detecting said fluorescence signal of said reagent adsorbed on said target.

10. The biochemical detecting method according to claim 9, wherein said biochemical detecting device further comprises:
a first substrate;
at least two first electrode sets located on said first substrate;
a second electrode set located on said first substrate and between said two first electrode sets; and
a second substrate covering said first substrate, each of said first electrode sets and said second electrode set.

11. The biochemical detecting method according to claim 10, wherein said reagent and said plurality of magnetic beads are able to move and interact between said first substrate and said second substrate when a first current is applied to said first electrode sets; said plurality magnetic beads are attracted by said second electrode set, and said target is identified and detected through a fluorescence signal of said reagent attached on said target when a second current is applied to said second electrode set; and a certain reaction of said target is initiated to generate a current signal to be detected when a third current is applied to one of said first electrode sets.

12. A biochemical detecting method for detecting a target in a plurality of magnetic beads of a liquid drop by a biochemical detecting device, comprising steps of:
mixing a target, a reagent and a plurality of magnetic beads to form a fluid, wherein said target is adsorbed by said plurality of magnetic beads;
driving said fluid by a first electrode set of said biochemical detecting device such that said fluid moves to a second electrode set of said biological detecting device;
attracting said plurality magnetic beads by said second electrode set; and
identifying and detecting said current signal of said reagent adsorbed on said target.

13. The biochemical detecting method according to claim 12, wherein said biochemical detecting device comprises:
a first substrate;
at least two first electrode sets located on said first substrate;
a second electrode set located on said first substrate and between said two first electrode sets; and
a second substrate covering said first substrate, each of said first electrode sets and said second electrode set.

14. The biochemical detecting method according to claim 13, wherein said reagent and said plurality of magnetic beads are able to move and interact between said first substrate and said second substrate when a first current is applied to said first electrode sets; said plurality magnetic beads are attracted by said second electrode set, and said target is identified and detected through a fluorescence signal of said reagent attached on said target when a second current is applied to said second electrode set; and a certain reaction of said target is initiated to generate a current signal to be detected when a third current is applied to one of said first electrode sets.
